(19) United States
(12) Patent Application Publication
(10) Pub. No.: US 2006/0085211 A1
(43) Pub. Date: Apr. 20, 2006

(54) Measurement tool for effective sales management

(76) Inventors: Mark William Bennett, Perdido Key, FL (US); Mark Alan Palmer, Santa Barbara, CA (US)

Correspondence Address: MARK RODGERS, 1590 SAN ROQUE ROAD, SANTA BARBARA, CA, 93105, US

(21) Appl. No.: 10/970,422

(22) Filed: Oct. 20, 2004

(51) Int. Cl. G06Q 99/00

(52) U.S. Cl. 705/1

(57) ABSTRACT

The invention is a tool to improve sales force effectiveness. The tool includes an assessment, and analyzing the assessment according to defined dependencies. The organization addresses the issues presented by the assessment according to the dependencies. Data is gathered and parameters are computed from the data to provide an ongoing scorecard for sales effectiveness,

### RELATED APPLICATIONS

Not Applicable

### FEDERALLY SPONSORED RESEARCH

Not Applicable

### SEQUENCE LISTING

Not Applicable

### BACKGROUND OF THE INVENTION

This invention relates to a tool which improves the effectiveness of sales management. The tool addresses the imbalances between expectations, accountability and actual results that exist in most sales organizations.

All organizations have unintentionally built in limitations to the success of sales. In a perfect world, success should only be limited by the market potential and resources applied. In fact most organizations have many self-limiting factors that prevent them form achieving their desired sales outcomes.

The reason that most sales organizations are self limited is that they do not have clearly defined and communicated goals, expectations and accountability. The following elements are key to achieving an effective sales organization:
Manage sales execution to a clearly defined set of sales activities
Manage sales execution to clearly defined set of business objectives
Manage sales execution to clearly defined set of expectations
Align all sales activities to common business objectives
Align expectations of sales execution with business objectives
Align sales execution with sales management expectations
Monitor and communicate sales performance and requirements to the organization
Identify and remove built in limitations for sales outcomes improvement

The opportunities to improve sales outcomes are limited to changing the following outcomes:
Increased Sales Activity
Increasing Average selling price
Reducing Sales cost
Increasing close ratio
Increasing Average deal size
Increasing balance of performance
Continuous identification and removable of built in limitations
Increasing quarterly forecast accuracy
   These outcomes have a very specific set of dependences. Success in any one will be limited by the weakest of its dependency chain.
Specific dependencies exist in the environment
Specific dependencies exist in the effectiveness of outcomes

It is the object of this invention to identify the self-imposed limitations in an order of dependency, and establishing a plan to remove limitations and improve desired outcomes using a well defined tool. The result will create a baseline against the perfect sales execution, providing both a vision for improvement and a baseline to measure improvement in the future.

### BRIEF SUMMARY OF THE INVENTION

The invention is a tool for improving the desired outcomes of a sales organization. The tool includes the steps of: asking a specific set of assessment yes or no questions; working issues related to the questions to achieve all yes answers to the questions; following a specific order in working the issues; gathering a specific set of data to evaluate ongoing sales performance;, computing a set of parameters from the data; and, monitoring the parameters periodically and continuously managing the issues related to the questions to maintain each parameter within a predetermined acceptable range on an ongoing basis.

In one embodiment, the assessment questions are;
Do you have a defined sales process?
Do your sales representatives have a well-defined compelling proposition?
Are sales force expectations defined and communicated?
Does the organization maintain sales tools for each step of the process?
Does the executive staff and sales organization use the same compelling proposition and target market?
Are sales management expectations defined and communicated?
Do you monitor each sales process step?
Do you monitor selling your defined compelling proposition and target market?
Do you monitor performance against defined expectations?
Is the sales process understood by the organization?
Is your compelling proposition and target market understood by the entire organization?
Is the organization held accountable for supporting sales process execution?
   In an aspect of the embodiment, the order of working issues to achieve all yes answers to the questions is the order of the questions as set forth above.

In a further embodiment, specific data to evaluate the effectiveness of sales performance is collected. In an aspect of the embodiment, the data is tracked on a quarterly basis.

In another embodiment, parameters obtained from the collected data are used to monitor ongoing performance effectiveness.

In an aspect of the embodiment, the parameters are tracked on a quarterly basis for eight successive quarters and the value of each parameter and the standard deviation of each parameter is managed to be within predetermined ranges by working the issues related to the questions. In one version, the orders of working these issues are specifically defined.

In a further embodiment the tool includes asking a second set of specific questions to both management and sales representatives, comparing the answers and taking action depending on whether there is agreement on the answers.

One such question is;
What was the major accomplishment for the representative last month?
   The action is to acknowledge the representative if there is agreement or to harmonize the expectations if no agreement.

Another question is;
What major issue did the representative have last month?
   The action is to acknowledge the issue and plan to address if there is agreement the issue is valid or to harmonize the expectations if no agreement.

Another question is;
What are the objectives for the representative for next month?
   No action is required if there is agreement or the action is harmonize the expectations if no agreement.

Another question is;
How did the representative perform against objectives last month?
   No action is required if there is agreement or the action is to harmonize the expectations if no agreement.

### BRIEF DESCRIPTION OF THE DRAWINGS

The invention will be better understood by referring to the figures.

FIG. 1 illustrates a first part of the tool and dependency structure.

FIG. 2 illustrates another part of the tool.

FIG. 3 illustrates the remaining parts of the tool.

FIG. 4 illustrates the data collected and analyzed to evaluate ongoing performance.

### DETAILED DESCRIPTION OF THE INVENTION

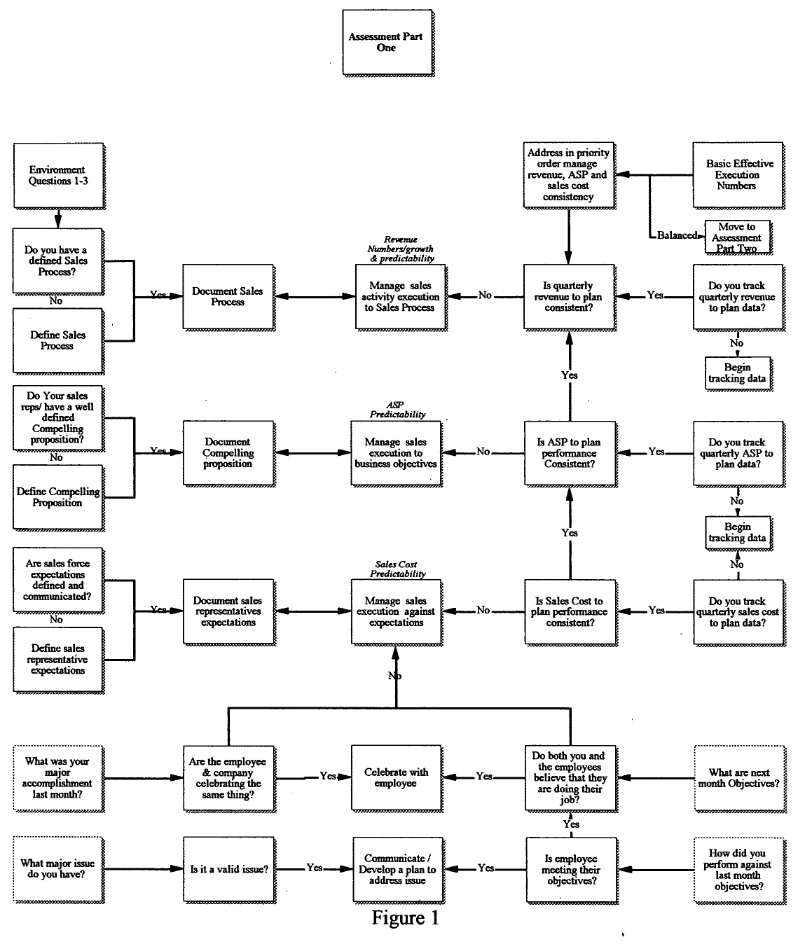

The invention constitutes both a unique and well defined assessment and improvement tool, as well as a monitoring tool. Turning first to assessment, we refer to FIGS. 1-3, where the operation of the invention is illustrated. A set of questions is asked to assess the organizations sales environment. Depending on the answers, action is taken to correct deficiencies. The order of the questions and actions thereby is critical. For instance it makes no sense to address the issue of does an organization have sales tools before ascertaining if there is a sales process to begin with, and a value proposition to be sold. Therefore a key aspect to the invention is the asking of 12 defined yes/no questions and acting on the answers to those questions in a specific order.

As shown in the top part of FIG. 1, the first and most important question to be asked is if there is a sales process. This issue must be addressed first. Continuing on in order of importance is defining the value proposition and target market, and then assuring that the expectations for sales are defined and communicated. The inventors provide worksheets for all of the assessment questions to help an organization create or improve the infrastructure associated with each topic. However, skilled sales managers will be able to develop their own versions of the individual plans, so the implementation details for each topic do not form a novel aspect of the invention. The process for each topic must include documentation and a procedure for training and monitoring to assure that adherence to each topic is strengthened and maintained over time.

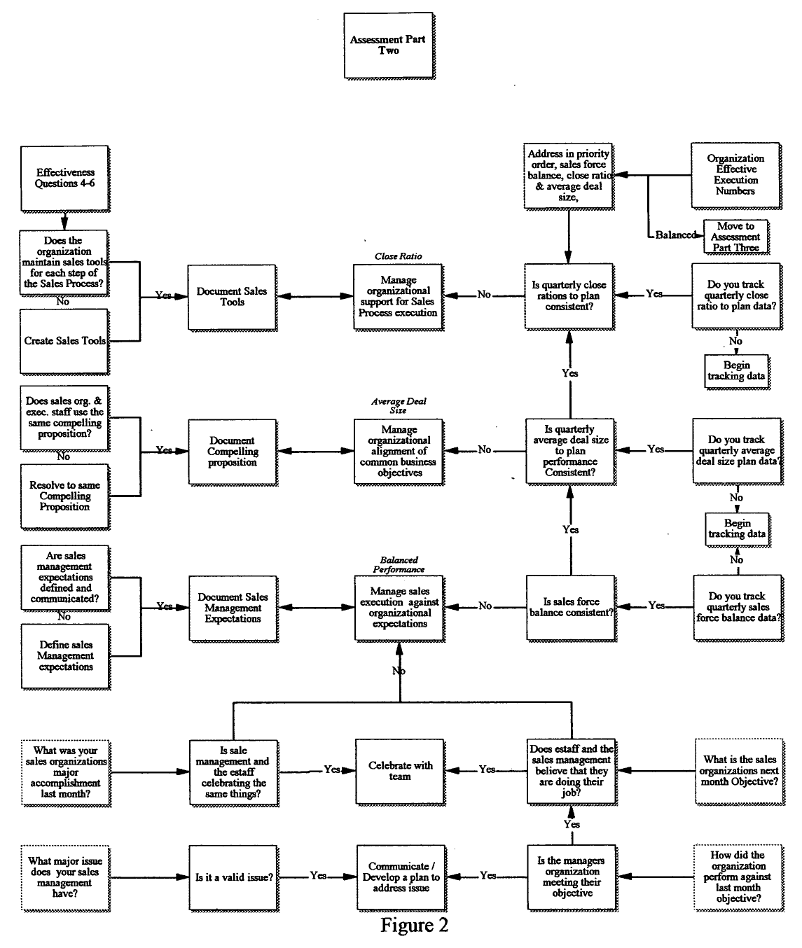

Thus the top half of FIG. 1 defines the most basic sales environment issues that must be addressed. Continuing on to the top half of FIG. 2 the sales organization is evaluated for possessing the next level of capability, including having and using tools, assuring that all levels of the organization share the same vision of the value proposition and market, and sales managers know what is expected from them. Documentation and training is required for these topics as well.

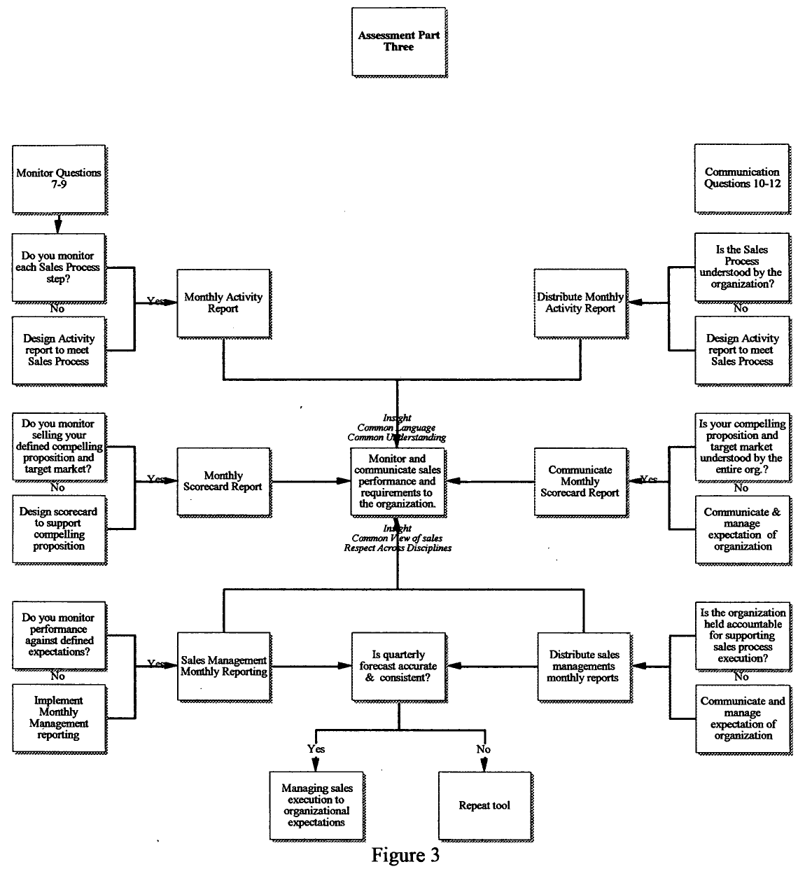

Finally as shown in FIG. 3, the organization is assessed for monitoring and communication. That the process is monitored and that the process is understood by the sales force is determined. Then that the value proposition and target market are maintained over time and understood by everyone in the company is checked. Last but not least, performance monitoring and accountability are verified. An organization that diligently follows the assessment and implementation process as described in the Figures will have much better understanding and control of the sales process than the vast majority of existing companies.

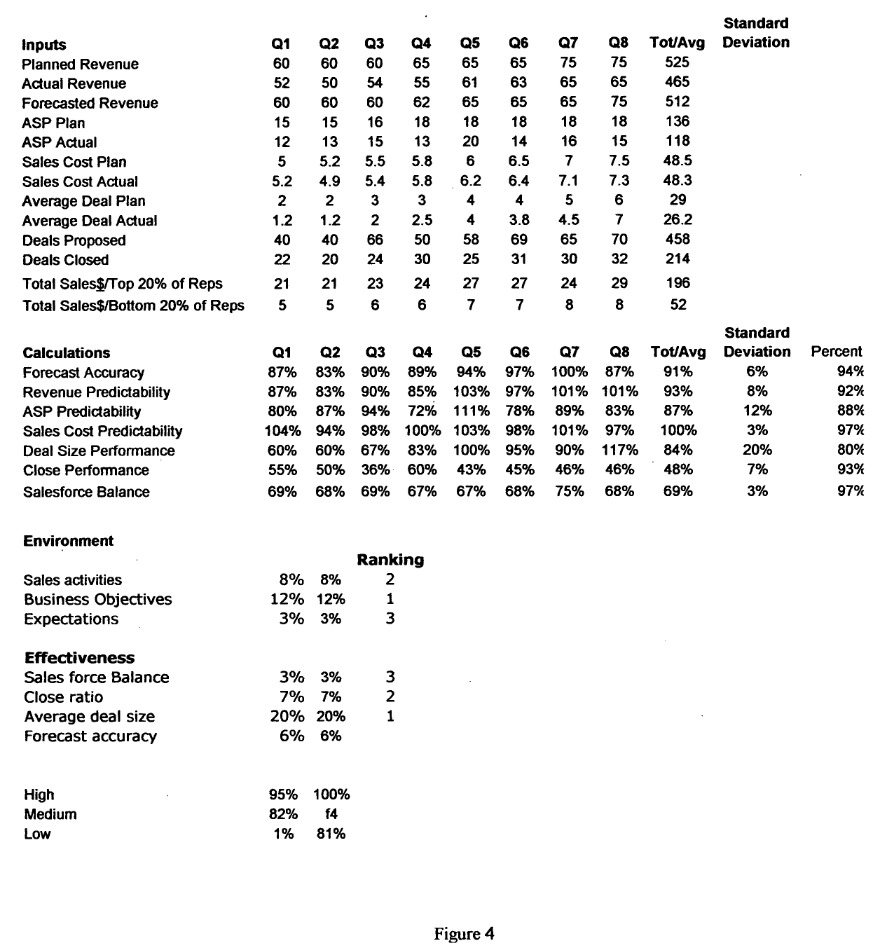

The other half of the tool is a concise approach to monitoring the effectiveness of performance of a sales organization against the desired outcomes. The monitoring tool is illustrated by the spread sheet in FIG. 4. The following data is acquired:
planned revenue, (PR)
actual revenue, (AR)
forecasted revenue, (FR)
average selling price plan, (ASPP)
average selling price actual, (ASPA)
sales cost plan, (SCP)
sales cost actual, (SCA)
average deal plan, (ADP)
average deal actual, (ADA)
deals proposed, (DP)
deals closed, (DC)
total sales percentage for top performing 20% of sales representatives; and, (T20)
total sales percentage for bottom performing 20% of sales representatives. (B20)
   Typically this data is acquired on a quarterly basis, although other time periods may be useful to particular organizations.

The raw data is then manipulated to obtain the following 7 parameters:
Revenue Predictability (RP)=AR/PR
Average Sales Price Predictability (ASPPr)=ASPA/ASPP
Sales Cost Predictability (SCPr)=SCA
Close Performance (CP)=DC/DP
Deal Size Performance Predictability (DSP)=ADA/ADP
Sales Performance Balance (SPB)=(1−T20/AR)+B20/AR
Forecast accuracy (FA)=AR/FR
   The key to continuous monitoring of sales performance is that these numbers be in a certain range, which assures that the sales operation is in balance. The concept of balance in this context simply means that no single individuals or functional aspects of sales are disproportionately weighted. For instance, if most of the sales activity is generated by a small fraction of the sales force, this is an indication that the sales force personnel of may need to be partially changed. If the average price performance is good, but the deal close rate is low, the pricing may be incorrect or the wrong target market has been identified.

So ranges for these parameters can be defined that insure balance and overall performance. Variance is also tracked to insure consistency and monitor improvement over time. A typical “scorecard” according to the invention is shown in FIG. 4, Data is collected for eight consecutive quarters, and the 7 parameters are monitored for absolute and consistency. The key to continuous monitoring of these sales performance numbers is that they provide
A cross check to the quality of your sales environment
They measure your desired outcomes
They highlight the weakest of dependencies to improving each individual outcome
They provide the foundation for sales communication
   The numbers are evaluated at several levels
Taking the average standard deviation from the average will identify the weakest
Resolving the weakest in the specific order to a common level is required. The process should be completed until the numbers reach the desired range of 90-100%

Balance of the first three parameters, revenue predictability, average selling price predictability and sale cost predictability, is significant. For example 100% in revenue predictability and 20% percent in average selling price will prevent the ability to improve close ratio. Whereas 80% revenue predictability with 80% Average selling Price will enable improving the close ratio. The specific order is important. For example, improvement in close ratio will be determined by effectiveness of revenue predictability and average selling price predictability. The order is determined by calculating the Standard Deviation of each of the first three parameters (revenue predictability, average selling price predictability and sale cost predictability) to determine the priority of implementation to obtain balance. Resolving the greatest deviation first will begin to bring balance amongst the predictability of revenue, average selling price and sales costs. Once balance of 80% or greater is achieved above, the order to address close ratio predictability, average deal size predictability and sales force balance is determined by calculating the standard deviation of each of the second three parameters. Resolving the greatest deviation first will bring balance between close ratio predictability, average deal size predictability and sales force balance.

Generally, most organizations will fall outside these ranges in the first few quarters, but continuous working of the parameters as described will bring the numbers into the good part of the range well within eight quarters. The monitoring and continuous improvement process may be maintained to good effect indefinitely. Thus the novel tool provides a deterministic, strictly numerical aid to monitoring and improving sales performance.

There is another important aspect to the tool which is not monitored numerically, but is key to achieving balance and accountability. Initially, and at set intervals going forward, four additional questions need to be asked. These questions need to be asked to each sales representative about their own work environment, and simultaneously asked of sales management about each sales representative. Then the manager's answers and the individual representative's answers can be compared. Specific actions are required for each answer depending on whether the representative and the manager are in agreement or have differing views of the same issue.

The questions and actions are as follows:
1. What was the major accomplishment for the representative last month?
   The action is to acknowledge the representative if there is agreement or to harmonize the expectations if no agreement.
2. What major issue did the representative have last month?
   The action is to acknowledge the issue and plan to address if there is agreement the issue is valid or to harmonize the expectations if no agreement.
3. What are the objectives for the representative for next month?
   No action is required if there is agreement or the action is harmonize the expectations if no agreement.
4. How did the representative perform against objectives last month?
   No action is required if there is agreement or the action is to harmonize the expectations if no agreement.
   These questions provide a link between management and sales that is usually missing and provide a backdrop of communications that is vital to successful implementation of the invention.

We claim:

1. A tool for improving the performance of a sales organization, comprising;
asking a specific set of assessment yes or no questions,
working issues related to the questions to achieve all yes answers to the questions,
following a specific order in working the issues,
gathering a specific set of data to evaluate ongoing sales performance,
computing a set of parameters from the data; and,
monitoring the parameters periodically and continuously managing the issues related to the questions to maintain each parameter within a predetermine acceptable range on an ongoing basis.

2. The tool of claim 1 wherein the questions are;
Do you have a defined sales process?
Do your sales representatives have a well-defined compelling proposition?
Are sales force expectations defined and communicated?
Does the organization maintain sales tools for each step of the process?
Does the executive staff and sales organization use the same compelling proposition and target market?
Are sales management expectations defined and communicated?
Do you monitor each sales process step?
Do you monitor selling your defined compelling proposition and target market?
Do you monitor performance against defined expectations?
Is the sales process understood by the organization?
Is your compelling proposition and target market understood by the entire organization? and
Is the organization held accountable for supporting sales process execution?

3. The tool of claim 2 wherein the order of working issues to achieve all yes answers to the questions is the order of the questions as set forth in clam 2.

4. The tool of claim 1 wherein the data to evaluate sales performance comprises;
planned revenue, (PR)
actual revenue, (AR)
forecasted revenue, (FR)
average selling price plan, (ASPP)
averge selling price actual, (ASPA)
sales cost plan, (SCP)
sales cost actual, (SCA)
average deal plan, (ADP)
average deal actual, (ADA)
deals proposed, (DP)
deals closed, (DC)
total sales percentage for top performing 20% of sales representatives; and, (T20)
total sales percentage for bottom performing 20% of sales representatives. (B20)

5. The tool of claim 4 wherein the data is tracked on a quarterly basis.

6. The tool of claim 4 wherein the parameters used to monitor ongoing performance comprise;
Revenue Predictability (RP)=AR/PR,
Average Sales Price Predictability (ASPPr)=ASPA/ASPP,
Sales Cost Predictability (SCPr)=SCA,
Close Performance (CP)=DC/DP,
Deal Size Performance Predictability (DSP)=ADA/ADP; and,
Sales Performance Balance (SPB)=(1−T20/AR)+B20/AR
Forecast accuracy (FA)=AR/FR,

7. The tool of claim 6 wherein the parameters are tracked on a quarterly basis for eight successive quarters and the value of each parameter and the standard deviation of each parameter is managed to be within predetermined ranges by working the issues related to the questions.

8. The tool of claim 7 wherein the order of managing the parameters comprises;
computing the quarter-to-quarter standard deviation of RP, ASPPr, and SCPr,
resolving the issues starting with the parameter with the largest standard deviation until all three parameters are above 80%,
computing the quarter-to-quarter standard deviation of CP, DSP, and SPB; and,
resolving the issues starting with the parameter with the largest standard deviation until all three parameters are above 80%.

9. The tool of claim 1 further comprising asking a second set of specific questions to both management and sales representatives, comparing the answers and taking action depending on whether there is agreement on the answers.

10. The tool of claim 9 wherein one question is;
What was the major accomplishment for the representative last month?
;and the action is to acknowledge the representative if there is agreement or harmonize the expectations if no agreement.

11. The tool of claim 9 wherein one question is;
What major issue did the representative have last month?
;and the action is to acknowledge the issue and plan to address if there is agreement the issue is valid or harmonize the expectations if no agreement.

12. The tool of claim 9 wherein one question is;
What are the objectives for the representative for next month?
;and no action is required if there is agreement or harmonize the expectations if no agreement.

13. The tool of claim 9 wherein one question is;
How did the representative perform against objectives last month?
;and no action is required if there is agreement or harmonize the expectations if no agreement.
